(19) United States
(12) Patent Application Publication
(10) Pub. No.: US 2012/0240081 A1
(43) Pub. Date: Sep. 20, 2012

(54) METHOD FOR MANAGING A PLURALITY OF ELECTRONIC BOOKS ON A COMPUTING DEVICE

(75) Inventors: Wong Hoo Sim, Singapore (SG); Seh Eing Lim, Singapore (SG); Kin Fui Chong, Singapore (SG); Willie Png, Singapore (SG)

(73) Assignee: CREATIVE TECHNOLOGY LTD, Singapore (SG)

(21) Appl. No.: 13/513,166

(22) PCT Filed: Nov. 15, 2010
(86) PCT No.: PCT/SG2010/000430

§ 371 Date: May 31, 2012

(30) Foreign Application Priority Data
Dec. 1, 2009 (SG) 200907969-0

(51) Int. Cl. G06F 3/048

(52) U.S. Cl. 715/811

(57) ABSTRACT

There is provided a method for managing a plurality of electronic books on a computing device. The electronic books may be stored in a plurality of storage sources, the plurality of storage sources being selected from, for example, local storage on the computing device, network-linked storage, network-linked electronic book retailers, and so forth.

### FIELD OF INVENTION

This invention relates to the management of electronic books on a computing device, the electronic books being from a plurality of sources.

### BACKGROUND

The popularity of electronic books is increasing at an exponential rate such that there is an undeniable trend of a decreasing number of printed hardcopy versions of books being sold. Some common reasons for the increasing popularity of electronic books include, for example, saving of physical storage space which is typically required for printed hardcopy versions of books, a lighter load due to not carrying printed hardcopy versions of books, convenience in purchasing an electronic book without hassles of shipment, and so forth.

However, users who possess a large number of electronic books would want to be able to manage their collection of electronic books and conveniently access any one of the large number of electronic books in their possession. Since each electronic book is typically in a form of a digital file, it would be typical for users to use existing file management applications to manage their collection of electronic books. But existing file management applications do not allow users to manage their collection of electronic books like how they would manage their printed hardcopy versions of books. For instance, when handling printed hardcopy versions of books, users may be able to obtain an overview of the contents of most books in a quick and convenient manner by looking at the back cover of the book in question.

Existing file management applications do not allow users to obtain much information other than file name and file creation details. Thus, users who use existing file management applications would not be able to replicate an experience of handling printed hardcopy versions of books. In this regard, users may be inconvenienced by having to run/open a plurality of electronic book files to review their respective contents before accessing the electronic book which they seek. This is undesirable as it may be tedious and it correspondingly diminishes the user experience when accessing a collection of electronic books.

It should be noted that there are applications which claim to be able to efficiently manage a collection of electronic books. However, these applications basically function like typical file management applications and include the disadvantages as mentioned earlier which diminishes the user experience when accessing at least one electronic book from a collection of electronic books.

Thus, it is evident that existing solutions which are currently available for managing a collection of electronic books may be enhanced to an extent that the user experience when accessing a collection of electronic books is improved, and is also able to replicate the quick and convenient user experience of handling printed hardcopy versions of books.

### SUMMARY

There is provided a method for managing a plurality of electronic books on a computing device. The electronic books may be stored in a plurality of storage sources, the plurality of storage sources being selected from, for example, local storage on the computing device, network-linked storage, network-linked electronic book retailers, and so forth.

The method includes determining titles of the electronic books stored in the local storage on the computing device, the titles being of electronic books available to a user; determining titles of the electronic books associated with a first profile of the user at the network-linked storage, the electronic books being stored in the network-linked storage, the titles being of electronic books available to the user; determining titles of the electronic books associated with a second profile of the user at the network-linked electronic book retailers, the electronic books being stored at the network-linked electronic book retailers, the titles being of electronic books available to the user; displaying the titles of the electronic books which are available to the user from the plurality of storage sources on the computing device; and allowing selection of the electronic books by the user, the selection of the electronic books being either a preview selection or an affirmative selection. The network-linked electronic book retailers may preferably include electronic book rental service providers.

It is advantageous that the affirmative selection of the electronic book by the user causes the electronic book to be obtained from at least one of the plurality of the storage sources to the computing device. The affirmative selection may be invoked by positioning a display selector onto the representation of the electronic book and with double tapping of the display selector on the representation of the electronic book. Obtaining the electronic book from the network-linked electronic book retailers may involve at least one electronic transaction.

The method may further include sending an electronic book search request to the network-linked electronic book retailers, where the search request includes at least one parameter such as, for example, title, author, genre, subject, keyword and so forth.

It is preferable that the titles of the electronic books are displayed in an organized manner, the organized manner being, for example, by alphabetical order, by author, by publication date, by genre, by subject and so forth.

Preferably, each of the first, and the second profiles include at least one parameter such as, for instance, a unique identity code of the user for identification of the user, preferences of the user and so forth.

The titles of electronic books from the network-linked electronic book retailers may be provided in accordance with the preferences of the user in the second profile. The titles of the electronic books may be represented using either cover art or textual content.

The preview selection of the electronic book may cause a summary of contents of the electronic book to be displayed for consumption by the user on the computing device. The summary of contents may include at least one advertisement related to either a word or a phrase from either the summary of contents or the title. Furthermore, the at least one advertisement may be dynamic and obtained from a network-linked advertisement repository. The preview selection may be invoked by either positioning a display selector onto the representation of the electronic book or with a single visual tap of the display selector on the representation of the electronic book.

The computing device may be, for example, a personal computer, a notebook computer, a handheld computer, an electronic book reader, a mobile phone and so forth.

The titles of the electronic books associated with the second profile of the user at the network-linked electronic book retailers may be continually updated with titles of newly arrived electronic books. Similarly, subscription-based purchases from the network-linked electronic book retailers may advantageously be carried out in a manner where updated/latest versions of electronic books are transmitted to the user once they are available without a need for a specific request from the user.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a flow chart for a method of the present application.

FIG. 2 shows a sample representation of a graphical user interface which relies upon the method of FIG. 1.

FIG. 3 shows an overview of a sample system which is able to support use of the method of FIG. 1.

### DESCRIPTION OF PREFERRED EMBODIMENTS

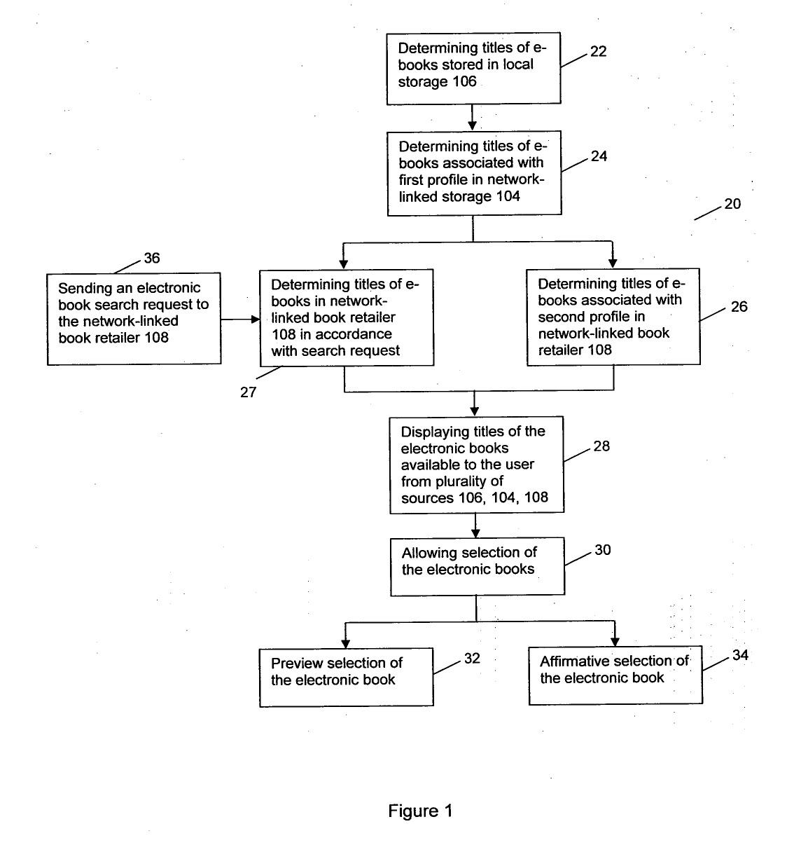

Referring to FIG. 1, there is shown a process flow for a method 20 for managing a plurality of electronic books on a computing device 102. The computing device 102 may include, for example, a personal computer, a notebook computer, a handheld computer, an electronic book reader, a mobile phone and the like. Referring to FIG. 3, there is shown an overview of an illustrative system 100 which is able to support use of the method 20. The electronic books may be stored in a plurality of storage sources in the system 100, the plurality of storage sources being for example, local storage 106 on the computing device 102, network-linked storage 104, network-linked electronic book retailers 108 and so forth. It should be appreciated that network-linked electronic book retailers 108 include electronic book rental service providers. This is because electronic book rental service providers also sell electronic books, albeit with a fixed tenure of time which determines a duration of time when the electronic book is able to be read by a user.

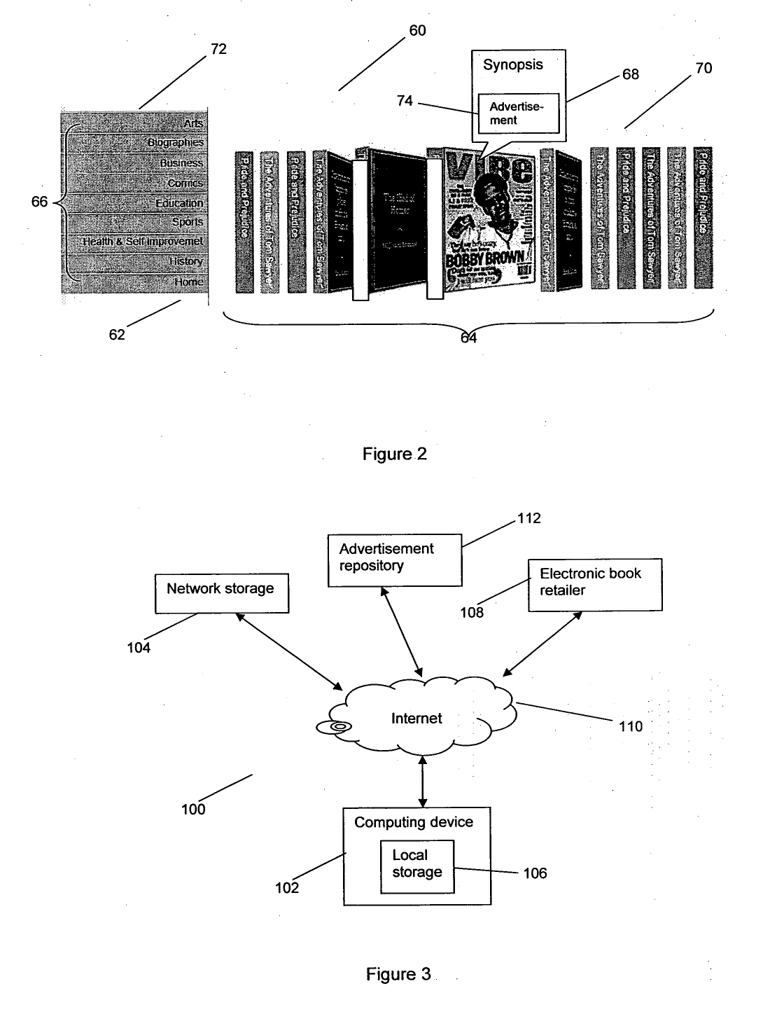

Referring to FIG. 2, there is shown a sample representation of a graphical user interface 60 which relies upon the method 20. As mentioned earlier, FIG. 3 shows an illustrative system 100 which enables the method 20 to be employed. For the sake of illustration, the Internet 110 is shown as the network which is able to enable the method 20. However, other closed/restricted networks may also employ the method 20. The method 20 will be described in detail in subsequent paragraphs with reference to FIGS. 1, 2 and 3. It should be appreciated that advantages in relation to use of the method 20 would be most apparent during instances when the plurality of the electronic books exceeds twenty as managing a smaller number of electronic books would not be a complicated endeavour.

The method 20 includes determining titles of the electronic books stored in the local storage 106 on the computing device 102 (22), the titles being of electronic books stored in the local storage 106 available to a user. The title of each electronic book may be determined from either a file name of an electronic book file, or metadata of the electronic book file.

The method 20 also includes determining titles of the electronic books associated with a first profile of the user at the network-linked storage 104 (24). The electronic books associated with the first profile of the user are stored in the network-linked storage 104, the titles being of electronic books available to the user. The first profile of the user may depend on at least a unique identity code of the user for identification of the user and preferences of the user. The first profile allows the user to have access to the user's electronic books stored on the network-linked storage 104 without a need to search through all electronic books stored on the network-linked storage 104. In a preferred embodiment, only the electronic books which are associated with the first profile of the user appear to be present on the network-linked storage 104. Other electronic books which are not associated with the first profile of the user may be hidden from the user on the network-linked storage 104.

Subsequently, there is a determining of titles of the electronic books associated with a second profile of the user at the network-linked electronic book retailers 108 (26). The electronic books associated with the second profile of the user are stored in the network-linked electronic book retailers 108, the titles being of electronic books available to the user. The second profile of the user may depend on at least a unique identity code of the user for identification of the user and preferences of the user. The second profile allows the user to have access to electronic books which may be of interest to the user. The network-linked electronic book retailers 108 determine a user's interest(s) from the second profile of the user. Access to the electronic books on the network-linked electronic book retailers 108 may be restricted in a manner where the user is only able to access a synopsis of content in the electronic books. This prevents the user from browsing electronic books at the network-linked electronic book retailers 108.

In a preferred embodiment, whenever there are new electronic books at the electronic book retailers 108, the network-linked electronic book retailers 108 would update the titles available to the user in accordance to the second profile, such that the user is continually made aware of new arrivals at the network-linked electronic book retailers 108 which may interest the user.

Other than relying on the second profile of the user, the user may send an electronic book search request to the network-linked electronic book retailers 108 to seek a particular electronic book(s) (36). The determination for the title(s) of the electronic book subsequently takes place in accordance with the search request (27). It should be appreciated that the search request may include parameters such as, for example, title, author, genre, subject, keyword, and so forth.

The method 20 then includes displaying the titles of the electronic books which are available to the user from the plurality of storage sources 106, 104, 108 on the computing device 102. The titles of the electronic books may be displayed in an organized manner, the organized manner being for example, by alphabetical order, by author, by publication date, by genre, by subject and so forth. The display of the titles of the electronic books may, for the sake of non-limiting illustration, be in the form of the graphical user interface 60 shown in FIG. 2 as displayed on a screen of the computing device 102.

The graphical user interface 60 shown in FIG. 2 has a primary portion 70 and a secondary portion 72. The non-limiting illustration of the graphical user interface 60 shows a “book-shelf” type of book display, where representations of books are shown to be arranged in rows like as if arranged on shelves. The primary portion 70 shows the representations of electronic books 64 available to the user, while the secondary portion 72 shows various subject categories 66 which the user's electronic books are categorized in. Non-limiting examples of the various subject categories 66 shown in the secondary portion 72 are arts, biographies, business, comics, education, sports, health & self improvement, and history. Each electronic book may be categorized into at least one of the various subject categories 66 by either a file name of an electronic book file, or metadata of the electronic book file.

When the user selects an option of “home” 62 from the secondary portion 72, the representations of all books 64 available to the user from the plurality of storage sources 106, 104, 108 are shown in the primary portion 70. Similarly, when the user selects an option of any of the various subject categories 66, the representations of all books 64 available to the user from that particular category is shown in the primary portion 70.

A spine showing a title of each book is one possible representation of each book, while a cover of the book may be another possible representation of each book. Both of these possible representations of each book are shown in FIG. 2. It may be possible that a book when represented by the spine showing the title may consequently be represented by the cover of the book (cover art) when the book is selected by the user, such that a. visual perception of the book being pulled out from the shelf is provided. This virtual action is also shown in FIG. 2. More books may be revealed by allowing scrolling through of the representations of the books in the primary portion 70.

The method 20 allows selection of the electronic books by the user (30), with the selection of the electronic books being either a preview selection of an electronic book (32) or an affirmative selection of an electronic book (34). The selection of the electronic books by the user (30) may be carried out via the aforementioned graphical user interface 60 as shown in FIG. 2. The affirmative selection of the electronic book (34) by the user causes the electronic book to be obtained from at least one of the plurality of the storage sources 106, 104, 108 to the computing device 102. In this regard, when a selected electronic book is not stored in the local storage 106 of the computing device 102, a file of the selected electronic book is consequently downloaded to the local storage 106 of the computing device 102 such that the selected electronic book can be accessed by the user. The affirmative selection (34) may be invoked by positioning a display selector onto the representation of the electronic book and double tapping of the display selector on the representation of the electronic book.

It should be noted that obtaining electronic books from the network-linked electronic book retailers 108 typically involves at least one electronic transaction (purchase). The at least one electronic transaction may be standard electronic transactions commonly used over the Internet 110. Besides either a one-off purchase or rental of an electronic book, the electronic transaction may also relate to subscription-based purchases of electronic books, where updated/latest versions of electronic books are able to be purchased in advance from the network-linked electronic book retailers 108. The subscription-based purchases may be carried out in a manner where updated/latest versions of electronic books are transmitted to the user once they are available without a need for a specific request from the user.

The preview selection of the electronic book (32) by the user causes a summary of contents (synopsis) of the electronic book to be displayed for consumption by the user on the computing device 102. In this regard, when a selected electronic book is not stored in the local storage 106 of the computing device 102, a summary file which contains a synopsis of the selected electronic book is consequently downloaded to the local storage 106 of the computing device 102 such that the synopsis of the electronic book can be accessed by the user. FIG. 2 shows an example of how the synopsis 68 may be presented to the user in the graphical user interface 60. The preview selection (32) may be invoked by either positioning a display selector onto the representation of the electronic book or with a single visual tap of the display selector on the representation of the electronic book.

The summary of contents (synopsis 68) may include at least one advertisement 74 related to either a word or a phrase from either the summary of contents (synopsis 68) or the title. The at least one advertisement 74 may be dynamic and obtained from a network-linked advertisement repository 112. The at least one advertisement 74 may be pushed to the computing device 102 or pulled from the computing device 102, depending on which known system of advertisement placement is employed in the method 20.

It should be appreciated that steps 22, 24, 26 and 27 of the process flow of the method 20 as described earlier need not be in an order as described in the preceding paragraphs. Steps 22, 24, 26 and 27 may be re-arranged amongst each other in any manner without deviating from the method 20.

Whilst there has been described in the foregoing description preferred embodiments of the present invention, it will be understood by those skilled in the technology concerned that many variations or modifications in details of design or construction may be made without departing from the present invention.

1. A method for managing a plurality of electronic books on a computing device, the electronic books being stored in a plurality of storage sources, the plurality of storage sources being selected from a group comprising: local storage on the computing device, network-linked storage, and network-linked electronic book retailers, the method including:
determining titles of the electronic books stored in the local storage on the computing device, the titles being of electronic books available to a user;
determining titles of the electronic books associated with a first profile of the user at the network-linked storage, the electronic books being stored in the network-linked storage, the titles being of electronic books available to the user;
determining titles of the electronic books associated with a second profile of the user at the network-linked electronic book retailers, the electronic books being stored at the network-linked electronic book retailers, the titles being of electronic books available to the user;
displaying the titles of the electronic books which are available to the user from the plurality of storage sources on the computing device; and
allowing selection of the electronic books by the user, the selection of the electronic books being either a preview selection or an affirmative selection,
wherein the affirmative selection of the electronic book by the user causes the electronic book to be obtained from at least one of the plurality of the storage sources to the computing device.

2. The method of claim 1, wherein the titles of the electronic books are displayed in an organized manner, the organized manner being selected from a group comprising: by alphabetical order, by author, by publication date, by genre, and by subject.

3. The method of claim 1, wherein each of the first, and the second profiles include at least one parameter selected from a group comprising: a unique identity code of the user for identification of the user and preferences of the user.

4. The method of claim 3, wherein the titles of electronic books from the network-linked electronic book retailers are provided in accordance with the preferences of the user in the second profile.

5. The method of claim 1, wherein the preview selection of the electronic book causes a summary of contents of the electronic book to be displayed for consumption by the user on the computing device.

6. The method of claim 5, wherein the summary of contents includes at least one advertisement related to either a word or a phrase from either the summary of contents or the title.

7. The method of claim 6, wherein the at least one advertisement is dynamic and obtained from a network-linked advertisement repository.

8. The method of claim 1, wherein the computing device is selected from a group comprising: a personal computer, a notebook computer, a handheld computer, an electronic book reader and a mobile phone.

9. The method of claim 1, wherein the titles of the electronic books are represented using either cover art or textual content.

10. The method of claim 9, wherein the preview selection is invoked by either positioning a display selector onto the representation of the electronic book or with a single visual tap of the display selector on the representation of the electronic book.

11. The method of claim 9, wherein the affirmative selection is invoked by positioning a display selector onto the representation of the electronic book and with double tapping of the display selector on the representation of the electronic book.

12. The method of claim 1, wherein obtaining the electronic book from the network-linked electronic book retailers involves at least one electronic transaction.

13. The method of claim 1, further including sending an electronic book search request to the network-linked electronic book retailers.

14. The method of claim 13, wherein the search request includes at least one parameter selected from the group comprising: title, author, genre, subject, and keyword.

15. The method of claim 1, wherein the network-linked electronic book retailers include electronic book rental service providers.

16. The method of claim 1, wherein the titles of the electronic books associated with the second profile of the user at the network-linked electronic book retailers are continually updated with titles of newly arrived electronic books.

17. The method of claim 1, wherein subscription-based purchases from the network-linked electronic book retailers are carried out in a manner where updated/latest versions of electronic books are transmitted to the user once they are available without a need for a specific request from the user.
